(19) United States
(12) Patent Application Publication
(10) Pub. No.: US 2014/0327966 A1
(43) Pub. Date: Nov. 6, 2014

(54) ANTIREFLECTION FILM

(71) Applicant: FUJIFILM Corporation, Tokyo (JP)

(72) Inventor: Takeharu TANI, Ashigarakami-gun (JP)

(21) Appl. No.: 14/338,547

(22) Filed: Jul. 23, 2014

Related U.S. Application Data
(63) Continuation of application No. PCT/JP2013/000280, filed on Jan. 22, 2013.

(30) Foreign Application Priority Data
Jan. 24, 2012 (JP) 2012-011634

(51) Int. Cl. G02B 1/11

(52) U.S. Cl. CPC G02B 1/11
USPC 359/586

(57) ABSTRACT

An antireflection film includes a first layer and a second layer formed on a substrate in this order from the substrate side, the second layer being formed to be in contact with an ambient medium. The first layer and the second layer are formed such that an average refractive index n1 of the first layer at a given wavelength λ0, an average refractive index n2 of the second layer at the given wavelength λ0, a film thickness d1 of the first layer, and a film thickness d2 of the second layer satisfy conditional expressions below:

0.96<n1/(n0×n0×n3)^{1/3}<1.04,

0.96<n2/(n0×n3×n3)^{1/3}<1.04,

0.8<d1×n1/(λ0/6)<1.2, and

0.8<d2×n2/(λ0/6)<1.2,

where n0 is a refractive index of the substrate at the given wavelength λ0, and n3 is a refractive index of the ambient medium at the given wavelength λ0.

### CROSS-REFERENCE TO RELATED APPLICATIONS

This application is a Continuation of PCT International Application No. PCT/JP2013/000280 filed on Jan. 22, 2013, which claims priority under 35 U.S.C §119 (a) to Japanese Patent Application No. 2012-011634 filed on Jan. 24, 2012. Each of the above applications is hereby expressly incorporated by reference, in its entirety, into the present application.

### TECHNICAL FIELD

The present invention relates to an antireflection film having a two-layer structure including a first layer and a second layer formed on a substrate.

### BACKGROUND ART

Conventionally, reflection on surfaces of optical elements cause decrease of light transmittance of lenses, etc., ghost or flare, reflection of external light on display screens, etc., and therefore high-performance antireflection is desired.

As a method for achieving such antireflection, a method where a multi-layer film having a single-layer, two-layer, three-layer or more layer structure is formed on a surface of an optical element to reduce reflection by utilizing an interference effect between the layers is proposed.

### DISCLOSURE OF INVENTION

For example, in a case where an antireflection film is formed by a single layer, the single layer is formed to have a refractive index of n^{1/2} relative to a refractive index n of the substrate and have a film thickness of λ0/4 relative to a design wavelength λ0. In this case, however, the reflection largely increases if the wavelength of incoming light deviates from the design wavelength λ0.

Further, an antireflection film having a two-layer structure including a layer of a high-refractive index material and a layer of a low-refractive index material formed from the substrate side is proposed. However, this antireflection film also has the problem of increase of reflection when the wavelength of incoming light deviates from a design wavelength, and has a narrow antireflection band.

Still further, an antireflection film having a three-layer or more layer structure including a layer of a high-refractive index material and a layer of a low-refractive index material is proposed. However, such an antireflection film has a drawback that the reflectance increases when light enters obliquely.

Yet further, an antireflection film having a so-called moth-eye structure, where an average refractive index is gradually changed from the substrate side, is proposed. This type of antireflection film, however, requires a certain film thickness, and has a weak mechanical strength, resulting in an unstable structure.

Further, each of Japanese Unexamined Patent Publication Nos. 10(1998)-268103, 10(1998)-227902 and 2010-281876 (hereinafter, Patent Documents 1, 2 and 3 respectively), for example, proposes an antireflection film including two layers that have refractive indices decreasing in a stepwise mariner from the substrate side; however, preferred refractive indices and film thicknesses thereof are not clear.

In view of the above-described circumstances, the present invention is directed to providing an antireflection film that can reduce reflectance in a wavelength range near a design wavelength when compared to conventional techniques, and has a stable structure that can be formed in a simple manner.

The antireflection film of the invention is an antireflection film comprising a first layer and a second layer formed on a substrate in this order from the substrate side, the second layer being formed to be in contact with an ambient medium, wherein the first layer and the second layer are formed such that an average refractive index n1 of the first layer at a given wavelength λ0, an average refractive index n2 of the second layer at the given wavelength λ0, a film thickness d1 of the first layer, and a film thickness d2 of the second layer satisfy conditional expressions below:

0.96<n1/(n0×n0×n3)^{1/3}<1.04,

0.96<n2/(n0×n3×n3)^{1/3}<1.04,

0.8<d1×n1/(λ0/6)<1.2, and

0.8<d2×n2/(λ0/6)<1.2,

where n0 is a refractive index of the substrate at the given wavelength λ0, and n3 is a refractive index of the ambient medium at the given wavelength λ0.

In the antireflection film of the invention, the first layer and the second layer may be formed such that the average refractive index n1 of the first layer at the given wavelength λ0, the average refractive index n2 of the second layer at the given wavelength λ0, the film thickness d1 of the first layer, and the film thickness d2 of the second layer satisfy conditional expressions below:

0.98<n1/(n0×n0×n3)^{1/3}<1.02,

0.98<n2/(n0×n3×n3)^{1/3}<1.02,

0.9<d1×n1/(λ0/6)<1.1, and

0.9<d2×n2/(λ0/6)<1.1.

The first layer may be a continuous film uniformly formed using a homogeneous material, and the second layer may include first areas and second areas having different refractive indices and alternately arranged along in-plane directions.

The first areas or the second areas of the second layer may be air gaps.

The first layer or the second layer may have a relief structure with a pitch not greater than the given wavelength λ0.

Each projecting area of the relief structure may have side surfaces that are formed perpendicular to a surface on which the projecting area is foamed.

The first layer may be made of MgF.

The second layer may be made of a resin.

The optical element of the invention is provided with the above-described antireflection film of the invention.

In the optical element of the invention, the given wavelength may be near the center of an operating wavelength range.

According to the antireflection film and the optical element of the invention, the antireflection film includes a first layer and a second layer formed on a substrate in this order from the substrate side, the second layer being formed to be in contact with an ambient medium, wherein the first layer and the second layer are formed such that an average refractive index n1 of the first layer at a given wavelength λ0, an average refractive index n2 of the second layer at the given wavelength λ0, a film thickness d1 of the first layer, and a film thickness d2 of the second layer satisfy conditional expressions below:

0.96<n1/(n0×n0×n3)^{1/3}<1.04,

0.96<n2/(n0×n3×n3)^{1/3}<1.04,

0.8<d1×n1/(λ0/6)<1.2, and

0.8<d2×n2/(λ0/6)<1.2,

where n0 is a refractive index of the substrate at the given wavelength λ0, and n3 is a refractive index of the ambient medium at the given wavelength λ0. The thus formed antireflection film of the invention can achieve wider-band antireflection than the conventional antireflection films having a two-layer structure. In particular, the antireflection film of the invention has a local minimum point of reflectance around the design wavelength, thereby achieving further reduction of reflectance near the center of the operating wavelength range. It should be noted that the basis for the numerical values in conditional expressions (1) to (4) will be described in detail later.

In particular, when the antireflection film of the invention is used in the visible light range, further reduction of reflectance around green light, which is highly visible to human eyes, can be achieved, thereby allowing further reduction of visually recognizable reflection light.

Further, the film thicknesses set as shown by the above conditional expressions allow reducing the film thicknesses.

In the case where the first layer or the second layer has a relief structure, for example, higher water repellency can be provided, which in turn provides an antifouling effect.

Further, since the structure of the antireflection film of the invention can be made to have a low aspect ratio when compared to a moth-eye structure, a structure with high mechanical strength can be achieved. This also allows improving mold releasability, thereby improving manufacturing suitability.

### BRIEF DESCRIPTION OF THE DRAWINGS

FIG. 1 is a perspective view illustrating the schematic structure of one embodiment of an antireflection film of the present invention,

FIG. 2 is a diagram for explaining the design concept of one embodiment of the antireflection film of the invention,

FIG. 3 is a diagram for explaining a production process for producing one embodiment of the antireflection film of the invention,

FIG. 4 is a diagram showing results of calculation of reflectance of one example of the antireflection film of the invention,

FIG. 5 is a diagram showing results of calculation for explaining a conditional expression with respect to refractive indices of first and second layers of the antireflection film of the invention, and

FIG. 6 is a diagram showing results of calculation for explaining a conditional expression with respect to film thicknesses of the first and second layers of the antireflection film of the invention.

### DESCRIPTION OF PREFERRED EMBODIMENTS

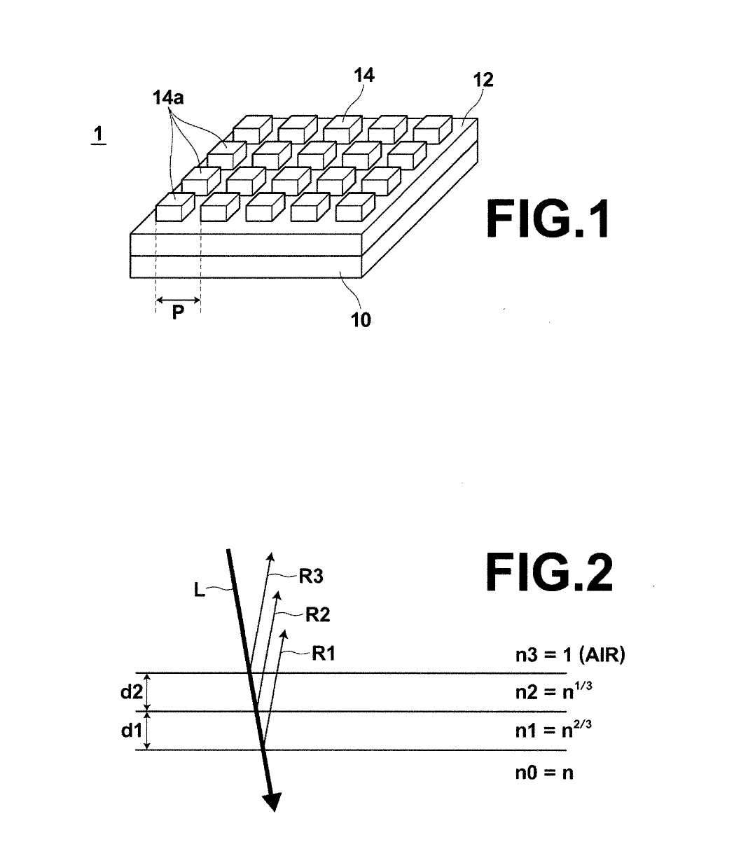

Hereinafter, one embodiment of an antireflection film of the present invention will be described in detail with reference to the drawings. FIG. 1 illustrates the schematic structure of an antireflection film of this embodiment.

As shown in FIG. 1, an antireflection film 1 of this embodiment includes, on a transparent glass substrate 10, a first layer 12 and a second layer 14 formed in this order from the glass substrate 10 side.

First, the basic design concept of the antireflection film 1 of this embodiment is described using FIG. 2. The antireflection film 1 of this embodiment is configured such that average refractive indices of the first layer 12 and the second layer 14 at a design wavelength λ0 decrease in geometric progression from the glass substrate 10 side toward an ambient medium (for example, air) on the light entrance side. Specifically, as shown in FIG. 2, assuming that the glass substrate 10 has a refractive index n0=n and the ambient medium (air) in contact with the second layer 14 has a refractive index n3=1, for example, the first layer 12 and the second layer 14 are formed such that the first layer 12 has an average refractive index n1=n^{2/3} and the second layer 14 has an average refractive index n2=n^{1/3}. That is, the first layer 12 and the second layer 14 are formed such that the average refractive index n1 of the first layer 12 at the design wavelength λ0 is near the value of (n0×n0×n3)^{1/3} and the average refractive index n2 of the second layer 14 is near the value of (n0×n3×n3)^{1/3}.

Then, a film thickness d1 of the first layer 12 and a film thickness d2 of the second layer 14 are set such that there is an optical path length difference of (⅔)·λ0 between reflection light R1 of incoming light L from the interface between the first layer 12 and the glass substrate 10 and reflection light R3 of the incoming light L from the interface between the air and the second layer 14, and there is an optical path length difference of (⅓)·λ0 between reflection light R2 of the incoming light L from the interface between the second layer 14 and the first layer 12 and the reflection light R3 of the incoming light L from the interface between the air and the second layer 14. That is, the first layer 12 and the second layer 14 are formed such that the value of n1×d1 is near the value of λ0/6 and the value of n2×d2 is near the value of λ0/6. It should be noted that the reflection light R1, the reflection light R2 and the reflection light R3 have almost the same intensities (amplitudes).

Based on the above-described design concept, the first layer 12 and the second layer 14 of the antireflection film 1 of this embodiment are formed such that the average refractive index n1 of the first layer 12 at the design wavelength λ0 and the average refractive index n2 of the second layer 14 at the design wavelength λ0 satisfy conditional expressions (1) and (2) below, and the film thickness d1 of the first layer 12 and the film thickness d2 of the second layer 14 satisfy conditional expressions (3) and (4) below (the basis for the numerical values in conditional expressions (1) to (4) will be described in detail later):

0.96<n1/(n0×n0×n3)^{1/3}<1.04 (1),

0.96<n2/(n0×n3×n3)^{1/3}<1.04 (2),

0.8<d1×n1/(λ0/6)<1.2 (3),

0.8<d2×n2/(λ0/6)<1.2 (4).

It should be noted that the ambient medium is not limited to air and may be any other medium.

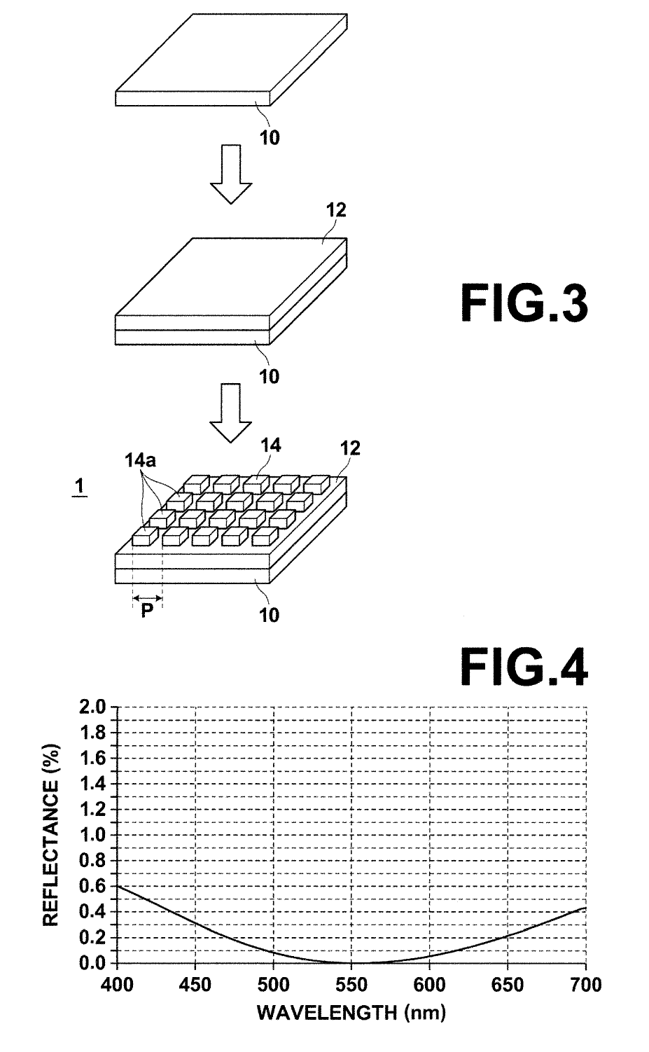

Next, one example of the antireflection film 1 of this embodiment is described with reference to FIG. 3.

The antireflection film 1 of this example is configured to achieve antireflection for the visible light range (400 nm to 700 nm), and the design wavelength is the center wavelength λ0=550 nm of the visible light range.

As a material forming the glass substrate 10, N-SK16, available from SCHOTT AG, is used. The glass substrate 10 has a refractive index of 1.622 at the design wavelength λ0, and a reflectance of 5.6% when the first layer 12 and the second layer 14 are not provided. It should be noted that this reflectance is normal incidence reflectance at the air interface.

As shown in FIG. 3, the first layer 12 is formed by forming a film of MgF₂ having a thickness of 66 nm (the film thickness d1) on the glass substrate 10 by vacuum deposition. The first layer 12 made of MgF₂ is a continuous film, and has a refractive index of 1.383 (the refractive index n1) at the design wavelength λ0.

As shown in FIG. 3, the second layer 14 is formed on the first layer 12 by patterning a resin material to form a relief structure using nanoimprinting. As the resin material, a UV-curable resin can be used. In this example, a resin material having a refractive index of 1.51 is used. As this type of resin material, a UV nanoimprinting resin PAK-02, available from Toyo Gosei Co., Ltd., for example, can be used.

The relief structure of the second layer 14 is formed, specifically, by arranging projecting areas 14a at a pitch of 200 nm (i.e., “P” shown in FIGS. 1 and 3 is 200 nm) along in-plane directions perpendicular to each other. Each projecting area 14a is formed to have an upper surface of 118 nm×118 nm and a height h (the film thickness d2) of 78 nm. Further, each projecting area 14a is formed such that the side surfaces thereof are substantially perpendicular (or perpendicular) to the surface on which the projecting area 14a is formed.

Since the pitch of the relief structure of the second layer 14 is not greater than any wavelength in the visible light range, as described above, the second layer 14 is optically regarded as a film having an average refractive index that is determined by a volume ratio between the projecting areas 14a and the depressed areas, which are air gaps. Therefore, in the case where the relief structure is formed using a resin material having a refractive index of 1.51, as described above, the second layer 14 can be regarded as a film having an average refractive index of 1.177 (the refractive index n2).

Values with respect to conditional expressions (1) to (4) shown above of the thus formed antireflection film 1 are as follows:

n1/(n0×n0×n3)^{1/3}=1.0018,

n2/(n0×n3×n3)^{1/3}=1.0018,

d1×n1/(λ0/6)=0.9958,

d2×n2/(λ0/6)=1.0015.

FIG. 4 shows results of calculation of the reflectance of the antireflection film 1 of the above-described example using a method for calculating a Fresnel reflectance of a multi-layer film. As shown in FIG. 4, the reflectance is not greater than 0.6% in the visible light range, and almost not greater than 0.1% at the design wavelength λ0=550 nm.

Next, the basis for the values in conditional expressions (1) to (4) is described.

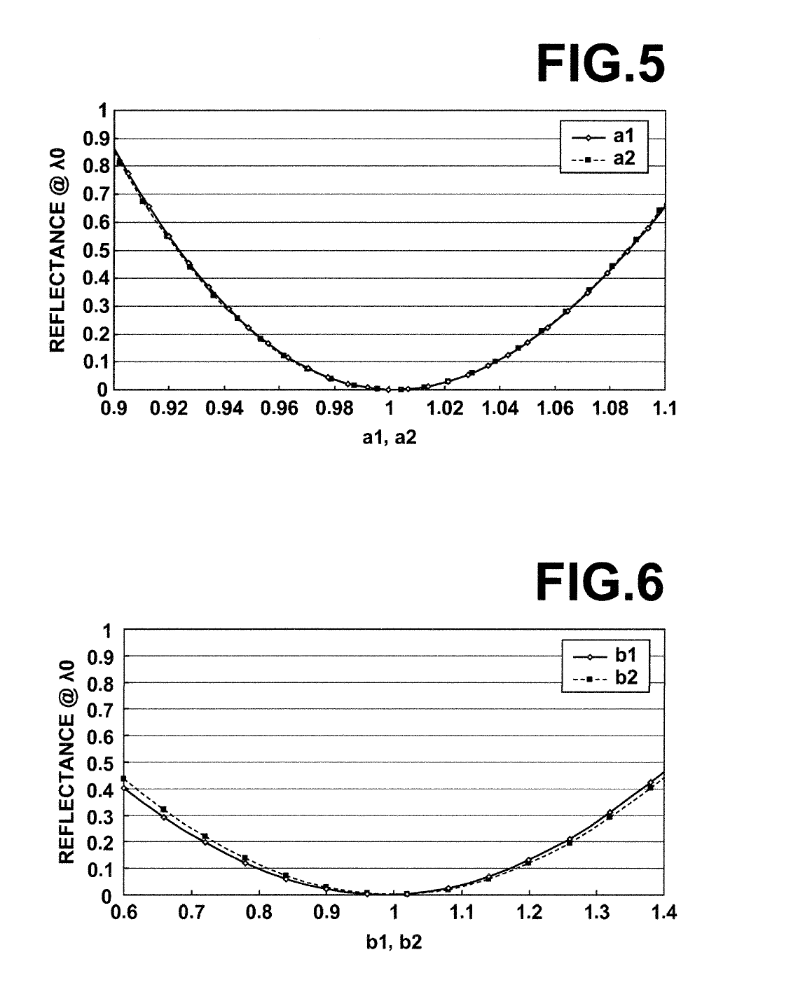

FIG. 5 shows results of calculation of the reflectance at the design wavelength λ0 when a1 and a2 are changed by changing the refractive index n1 of the first layer 12 and the refractive index n2 of the second layer 14 relative to those in the above-described configuration of example 1, where al stands for n1/(n0×n0×n3)^{1/3} in conditional expression (1) shown above and a2 stands for n2/(n0×n3×n3)^{1/3} in conditional expression (2) shown above.

FIG. 6 shows results of calculation of the reflectance at the design wavelength λ0 when b1 and b2 are changed by changing the film thickness d1 of the first layer 12 and the film thickness d2 of the second layer 14 relative to those in the above-described configuration of example 1, where b1 stands for d1×n1/(λ0/6) in conditional expression (3) shown above and b2 stands for d2×n2/(λ0/6) in conditional expression (4) shown above.

As can be seen from the results shown in FIGS. 5 and 6, when the first layer 12 and the second layer 14 are formed to satisfy the values of conditional expressions (1) to (4) shown above, a reflectance of around 0.1% can be achieved, and thus a sufficient antireflection effect can be provided.

It should be noted that an even higher antireflection effect can be provided when the first layer 12 and the second layer 14 are formed to satisfy values of conditional expressions (5) to (8) below:

0.98<n1/(n0×n0×n3)^{1/3}<1.02 (5),

0.98<n2/(n0×n3×n3)^{1/3}<1.02 (6),

0.9<d1×n1/(λ0/6)<1.1 (7),

0.9<d2×n2/(λ0/6)<1.1 (8).

It should be noted that, although the relief structure of the second layer 14 of the antireflection film 1 of the above-described example is formed using nanoimprinting, this is not intended to limit the invention. The relief structure may be formed using any other existing process. Further, not only the second layer 14 but also the first layer 12 may have a relief structure similarly to the second layer 14.

Further, although the second layer 14 of the antireflection film 1 of the above-described example is formed by the projecting areas 14a and the depressed areas which are air gaps, the depressed areas may not necessarily be air gaps, and may be filled with a material having a refractive index that is different from the refractive index of the projecting areas 14a, so as to satisfy the refractive index n2 of the above-described conditional expression.

The method used to form the low-refractive index layer is not limited to the above-described method for forming the relief structure. For example, the low-refractive index layer may be formed using a material having a low average refractive index, such as a material containing silica aerogel or hollow particles, or using a film having a low average refractive index, such as a boehmite film. Further, a plurality of such low-refractive index layers may be formed in the form of a layer stack. Still alternatively, the low-refractive index layer may be formed by etching a surface of a base material to form the two-level relief structure.

The antireflection film 1 of the above-described embodiment can be formed on an optical element. Examples of the optical element include lenses, prisms, filters, window materials, etc. The antireflection film 1 suitable for the optical element can be formed by setting the above-described design wavelength λ0 near the center of the operating wavelength range of the optical element.

What is claimed is:

1. An antireflection film comprising a first layer and a second layer formed on a substrate in this order from the substrate side, the second layer being formed to be in contact with an ambient medium, wherein
the first layer and the second layer are formed such that an average refractive index n1 of the first layer at a given wavelength λ0, an average refractive index n2 of the second layer at the given wavelength λ0, a film thickness d1 of the first layer, and a film thickness d2 of the second layer satisfy conditional expressions below:
0.96<n1/(n0×n0×n3)^{1/3}<1.04,
0.96<n2/(n0×n3×n3)^{1/3}<1.04,
0.8<d1×n1/(λ0/6)<1.2, and
0.8<d2×n2/(λ0/6)<1.2,
where n0 is a refractive index of the substrate at the given wavelength λ0, and n3 is a refractive index of the ambient medium at the given wavelength λ0.

2. The antireflection film as claimed in claim 1, wherein the first layer and the second layer are formed such that the average refractive index n1 of the first layer at the given wavelength λ0, the average refractive index n2 of the second layer at the given wavelength λ0, the film thickness d1 of the first layer, and the film thickness d2 of the second layer satisfy conditional expressions below:
0.98<n1/(n0×n0×n3)^{1/3}<1.02,
0.98<n2/(n0×n3×n3)^{1/3}<1.02,
0.9<d1×n1/(λ0/6)<1.1, and
0.9<d2×n2/(λ0/6)<1.1.

3. The antireflection film as claimed in claim 1, wherein the first layer is a continuous film uniformly formed using a homogeneous material, and the second layer includes first areas and second areas having different refractive indices and alternately arranged along in-plane directions.

4. The antireflection film as claimed in claim 2, wherein the first layer is a continuous film uniformly formed using a homogeneous material, and the second layer includes first areas and second areas having different refractive indices and alternately arranged along in-plane directions.

5. The antireflection film as claimed in claim 3, wherein the first areas or the second areas of the second layer are air gaps.

6. The antireflection film as claimed in claim 4, wherein the first areas or the second areas of the second layer are air gaps.

7. The antireflection film as claimed in claim 1, wherein the first layer or the second layer has a relief structure with a pitch not greater than the given wavelength λ0.

8. The antireflection film as claimed in claim 7, wherein each projecting area of the relief structure has side surfaces that are formed perpendicular to a surface on which the projecting area is formed.

9. The antireflection film as claimed in claim 1, wherein the first layer is made of MgF.

10. The antireflection film as claimed in claim 1, wherein the second layer is made of a resin.

11. An optical element comprising the antireflection film as claimed in claim 1.

12. The optical element as claimed in claim 11, wherein the given wavelength is near the center of an operating wavelength range.
